(19) United States
(12) Patent Application Publication
(10) Pub. No.: US 2009/0184160 A1
(43) Pub. Date: Jul. 23, 2009

(54) Envelope and system for returning lost items

(76) Inventor: Geoffrey H. Nudd, San Francisco, CA (US)

Correspondence Address: William C. Milks, III, 401 Florence Street, Palo Alto, CA, 94301, US

(21) Appl. No.: 12/319,672

(22) Filed: Jan. 8, 2009

Related U.S. Application Data
(60) Provisional application No. 61/011,590, filed on Jan. 18, 2008.
(60) Provisional application No. 61/011,591, filed on Jan. 18, 2008.
(60) Provisional application No. 61/011,594, filed on Jan. 18, 2008.
(60) Provisional application No. 61/011,595, filed on Jan. 18, 2008.
(60) Provisional application No. 61/011,617, filed on Jan. 18, 2008.
(60) Provisional application No. 61/011,620, filed on Jan. 18, 2008.
(60) Provisional application No. 61/011,676, filed on Jan. 18, 2008.

(51) Int. Cl. G06F 17/00

(52) U.S. Cl. 235/375

(57) ABSTRACT

An apparatus and system for returning an object which has been lost to its proper owner. A protective shipping container is sent to a person who has found a lost object (“finder”) at the address specified by the finder. Upon receiving the shipping container, the finder inserts the found object and removes a separable portion of the shipping container on which the finder's address is identified. In doing so, address identifying information of the object owner, which is pre-printed and/or pre-affixed to the shipping container, is exposed which facilitates the sending of the shipping container containing the found object to its owner. The separable portion of the shipping container also contains a reward which is provided to the finder as an incentive for returning the item. The finder seals the shipping container so that it may be sent via a courier such as the U.S. Postal Service or Federal Express.

### CROSS-REFERENCE TO RELATED APPLICATIONS

This application relates to U.S. Provisional Patent Applications No. 61/011,590 filed on Jan. 18, 2008, entitled SYSTEMS AND METHODS FOR NOTIFYING AN OWNER ABOUT A FOUND ITEM IN A LOST-AND-FOUND SERVICE, 61/011,591 filed on Jan. 18, 2008, entitled SYSTEM FOR MANAGING EXCEPTIONS ASSOCIATED WITH A LOST-AND-FOUND SERVICE, 61/011,594 filed on Jan. 18, 2008, entitled SYSTEMS AND METHODS FOR PROVIDING INCENTIVES IN A LOST-AND-FOUND SYSTEM, 61/011,595 filed on Jan. 18, 2008, entitled LOST AND FOUND COMBINED LABEL AND REGISTRATION, 61/011,617 filed on Jan. 18, 2008, entitled CALL CENTER AND FULFILLMENT CENTER FOR A LOST-AND-FOUND SYSTEM, 61/011,620 filed on Jan. 18, 2008, entitled SYSTEM FOR PROVIDING INSURANCE ASSOCIATED WITH A LOST-AND-FOUND SERVICE, and 61/011,676 filed on Jan. 18, 2008, entitled ENVELOPE AND SYSTEM FOR RETURNING LOST ITEMS, the disclosures of which are hereby incorporated herein in their entirety by this reference.

### BACKGROUND OF THE INVENTION

1. Field of the Invention

The present invention relates to shipping containers and systems for returning lost objects.

2. Description of the Prior Art

References Cited
U.S. Patent Documents

| | | |
|---|---|---|
| 4,271,352 | June 1981 | Thomas |
| 5,180,192 | January 1993 | Herbert |
| 5,732,401 | March 1998 | Conway |
| 5,809,481 | September 1998 | Baron, et al. |
| 5,841,116 | November 1998 | Lewis |
| WO1999018818 | April 1999 | Biles |
| 5,933,829 | August 1999 | Durst |
| 5,936,527 | August 1999 | Isaacman |
| 5,949,335 | September 1999 | Maynard |
| 5,955,965 | September 1999 | Colandruccio |
| 5,962,834 | October 1999 | Markman |
| 6,025,780 | February 2000 | Bowers, et al. |
| 6,040,774 | March 2000 | Schepps |
| 6,259,367 | July 2001 | Klein |
| US20030083939 | October 2001 | Klein |
| US20010037248 | November 2001 | Klein |
| US20010053981 | December 2001 | Wyssen |
| 6,025,780 | February 2002 | Bowers |
| 6,449,611 | September 2002 | Frankel, et al. |
| WO2002084615 | October 2002 | Klein |
| 6,533,172 | March 2003 | Popp |
| 6,546,088 | April 2003 | Campbell |
| US20030083939 | May 2003 | Wohl |
| US20030194079 | October 2003 | Scott |
| 20030182140 | September 2003 | Furuya, et al. |
| 6,662,078 | December 2003 | Hardgrave, et al. |
| US20040019609 | January 2004 | Orton, et al. |
| US20040002998 | January 2004 | Takahashi, et al. |
| 6,747,560 | June 2004 | Stevens |
| US20040124239 | July 2004 | Feld |
| US20050035860 | February 2005 | Taylor, et al. |
| 6,965,866 | March 2005 | Klein |
| 6,967,577 | November 2005 | Stanton, et al. |
| US20060028343 | February 2006 | Taylor |
| US20060087440 | April 2006 | Klein |
| US20060148443 | July 2006 | Bernard |
| 7,135,977 | November 2006 | Bernard, et al. |
| US20060265298 | November 2006 | Lee |
| US20060282325 | December 2006 | Martin |
| WO2007045992 | April 2007 | Hosp, et al. |
| 7,210,625 | May 2007 | McNutt, et al. |
| 7,230,534 | June 2007 | Elledge |
| 7,259,680 | August 2007 | Popp |
| US20070214021 | September 2007 | McLaughlin |
| US20070252697 | November 2007 | Elledge |

The use of identification tags and reward offers is the most well-known and prevalent technique for returning lost items to their owners. For example, tags may be placed on luggage, cell phones, computer equipment, or any item capable of being lost, and making it possible for the finder to locate the owner to arrange for return and possible reward by the owner to the finder. Techniques for tagging items to identify their owners are well-known and described in the prior art.

However, known techniques have not been broadly adopted in the marketplace. Impediments to the broad adoption of such “lost-and-found” techniques include the problem of making it economic and convenient for: a) an object finder to return the item to its owner and/or b) to provide a reward for the finder for returning the item. Furthermore, techniques disclosed in the prior art often require numerous processing steps that delay the return of the item to the owner after it has been found. An additional problem is that existing apparatuses and systems for enabling a finder to return an item to its owner compromise the anonymity of the finder.

Specifically, conventional techniques typically specify that the finder must return the object to a specific location. For example, Klein, U.S. Pat. No. 6,259,367 suggests that a lost object must be returned to a “package delivery service or return location” before the owner is subsequently identified by reading an RFID tag. That patent suggests that after the item owner is identified, the system “may print address label or overnight package delivery service label.” Importantly, the item finder must go to a specified return location or return the item to a package delivery service before the owner is identified and the object can be routed to its final destination. This ordering of steps and the technology employed add expense and inconvenience to the process.

Expense, inconvenience, and additional time are required by such an RFID system because an RFID reader is required before the owner can be identified. Thus, either there must be many RFID readers distributed across a variety of locations that are readily available to the finders, or the identification of the owner and subsequent labeling of the found item and sending the item to the owner must be performed at a central logistics location, thus both adding an expensive processing step and delaying the return of the item to its owner.

Another example is Taylor, U.S. Pat. No. 6,967,577 which suggests that the object be returned to a location using an RFID reader capable of reading an RFID tag on an object, with example locations including “a law enforcement agency, as a component of a traffic control signal, at a pawnbroker's facility, or at a flea market.” Again, these systems require that an item finder travel to a location which can process the found item. This is an inconvenience which can delay the return of the item, delay discovery that the item has been found, and add expense and inconvenience to the overall process of returning a lost item to its owner.

Other prior art discloses lost-and-found systems for identifying owners, but the art is non-specific about particular apparatuses and systems for returning the item, thus leaving an outstanding problem as to how to do so economically and conveniently. Examples of such systems include Feld, U.S. Pat. App. No. US20040124239A1, Stanton, U.S. Pat. No. 6,967,577, Herbert, U.S. Pat. No. 5,180,192, Klein, U.S. Pat. No. 6,259,367, Lewis, U.S. Pat. No. 5,841,116, McNutt, U.S. Pat. No. 7210625, Elledge, U.S. Pat. No. 7,230,534, Stanton, U.S. Pat. App. No. US20060028343A1, Stanton, U.S. Pat. App. No. US20050035860A1, Frankel, U.S. Pat. No. 6,449,611, Takahashi, U.S. Patent App. No. US20040002998A1, Wyssen, U.S. Pat. App. No. US20010053981A1, Klein, U.S. Pat. App. No. W02002084615A1, and Martin, U.S. Pat. App. No. US20060282325A1.

Additionally, a service provided by www.imhonest.com allows an object finder to schedule a courier pickup of the found item or drop the item off at any UPS Store. The www.imhonest.com system increases expense and inconvenience because it requires that the object finder either: a) return the found object to a specific location (any UPS Store® location) or b) schedule a courier pickup. The former alternative requires that the finder make a special trip to return the item, while the latter alternative typically requires that the finder be present when the courier arrives to pick up the item. Furthermore, the latter alternative of a courier pickup is an additional expense to the overall lost-and-found process.

Separate to these interactions required to retrieve a found object from its finder in order to facilitate its return, www.imhonest.com mails a reward to the item finder. Thus, yet another disadvantage is that the www.imhonest.com system requires two outbound mailings from www.imhonest.com: one pickup or drop-off for the item and another mailing for the reward. Additionally, to accommodate routing/addressing of a found item to its owner, the courier pickup alternative requires the execution of additional process steps that add cost, inconvenience, and delay; specifically, at least one of the following steps must occur: a) the finder must learn the item owner's address and then address the package for shipping, b) the processes of couriers such as Federal Express and UPS must be configured to enable couriers to selectively distribute a preaddressed shipping container to the item finder upon pickup of the item, or c) an item must be shipped after pickup from the item finder to an intermediate lost-and-found logistics facility whereby the item can be subsequently addressed to its final destination. Each of these alternatives creates significant inconvenience and cost. Alternative a) also has the disadvantage of compromising the anonymity of the item finder to the item owner.

Also, a problem exists that an incentive is often necessary in order to encourage an item finder to return the item to its owner, and notwithstanding www.imhonest.com, the prior art is not specific about the logistics required to provide such an incentive to a finder. Incentive systems in lost-and-found have not become prevalent in the marketplace in part because it has not been shown how to economically and conveniently provide the incentive to the finder.

These problems are significant and have delayed the widespread and broad adoption of a general lost-and-found system. Past systems for returning items and providing an incentive to finders for returning items have been unnecessarily costly and inconvenient. The various embodiments of the invention disclosed herein provide substantial improvements and address these problems.

### SUMMARY OF THE INVENTION

There exists a need for a more economical and convenient system for returning lost items to their owners. There also exists a need for an economical and convenient system for providing an incentive to an item finder as a reward for returning the item, while protecting against fraudulent distribution of such an incentive.

Moreover, simple systems for locating and/or retrieving objects which can be incorporated into a conventional express courier, postal, or other commercial data processing or communications infrastructure would likewise enhance efficiency while also achieving a cost economy as a result of integration with existing hardware and/or software.

One embodiment of the present invention provides a shipping container used for returning a lost object to its owner comprising: a) a protective interior to contain and protect a found item, b) at least one portion of the shipping container which communicates the address of the item finder and/or contains a reward to the finder for finding the object, c) at least one portion of the shipping container which communicates a forwarding address, and d) an insignia or other indicator of a guarantee of payment to a courier in exchange for shipping the container. A “shipping container” is one or more storing means which can be sent as a package simultaneously. In a preferred embodiment of the present invention, the at least one portion of the shipping container which communicates the address of the item finder and/or contains a reward to the finder for finding the object is separable from the shipping container. In another preferred embodiment of the present invention, when the separable portion of the envelope is removed which communicates the address of the item finder and/or contains a reward to the finder for finding the object, the address identifying information of the owner is visibly exposed while being otherwise concealed so as to avoid confusion of the courier service. In another preferred embodiment of the present invention, the shipping container also includes directions for the item finder and/or contractual terms of use of the shipping container and/or lost-and-found service.

In another aspect, the invention comprises a system for returning a lost item to its owner using a shipping container comprising: a) a protective interior to contain and protect a found item, b) at least one portion of the shipping container which communicates the address of the item finder and/or contains a reward to the finder for finding the object, c) at least one portion of the shipping container which communicates a forwarding address, and d) an insignia or other indicator of a guarantee of payment to a courier in exchange for shipping the container. A tag and/or label is affixed to an item which contains directions for contacting a lost-and-found service and unique identifying information. The unique identifying information on the tag and/or label is captured in a database with records for a plurality of tags and/or labels, wherein a tag and/or label and its unique identifying information corresponds to one or more records in the database containing a variety of information about the item and/or its owner.

Upon finding an item, the person and/or entity finding the item (the “item finder”) contacts a lost-and-found service provider, and the lost-and-found service provider requests the address of the item finder and the unique identifying information on the tag and/or label. A “lost-and-found service provider” and/or “lost-and-found service” is any person, organization, and/or entity that facilitates the return of an item to its proper possessor.

Upon receiving the address of the item finder and the unique identifying information on the tag and/or label, the lost-and-found service identifies the item and its owner using the aforementioned database and sends a shipping container to the item finder, the shipping container having the aforementioned characteristics and with size and protective characteristics appropriate to the size and fragility of the item being returned. In a preferred embodiment of the present invention, upon receiving the shipping container from the lost-and-found service provider, the item finder places the found item in an internal portion of the shipping container, seals the shipping container, removes a separable portion of the shipping container which contains the item finder's address and/or a reward for the finder, and returns the shipping container to the courier service.

In another preferred embodiment of the present invention, a determination is made by a lost-and-found service provider before the shipping container is sent to the item finder as to the forwarding address for the shipping container. A forwarding address is the address to which the shipping container should be sent after the shipping container is sent to an item finder. Criteria for the determination of the forwarding address may include but are not limited to, individually or in any combination: whether the address of the item owner has been confirmed, whether the item owner has chosen to claim the lost item, whether the item owner has been successfully contacted, whether the item owner has authorized payment of an incentive to the item finder, whether the item is insured for loss via the lost-and-found service, whether the item owner has authorized payment of any other fees, and/or whether there exists some payment means for any fees required by the lost-and-found service provider. Via this determination of the forwarding address, the item can be sent directly from the item finder to the item owner if the lost-and-found service provider has successfully confirmed the owner's address and a source of payment, if necessary, or the item can be sent in the shipping container from the item finder to the lost-and-found service provider and/or other destination for subsequent processing.

In another preferred embodiment of the present invention, upon contact of the item owner after an item is found, the unique identifying information on the found item is provided to the item owner by which the item owner can obtain information about the status of the item from the lost-and-found service provider. In another preferred embodiment of the present invention, unique identifying information is generated by software and a computer system and is provided to the item owner, thus enabling the owner to obtain information about the status of the item from the lost-and-found service provider.

In another preferred embodiment of the present invention, the item owner is provided unique tracking information contained on the found item and/or a shipping container used to ship the found item, wherein said tracking information can be used with a courier such as Federal Express, UPS, or U.S. Postal Service to identify the shipping status and/or location of an item in transit. In another preferred embodiment of the present invention, the item owner is provided with the name of the courier for which the tracking identifying information may be used.

The apparatus and method in accordance with the various embodiments of the present invention described herein have the advantages that: a) the item finder does not need to travel to a specified location in order to return the item, b) the item finder can remain anonymous to the item owner, thus mitigating privacy concerns, c) the lost-and-found service provider reduces cost by delivering both the reward for the finder and the means of returning the found item in one shipment, d) the finder does not have to arrange to meet a scheduled courier service, thus reducing cost and inconvenience, e) the finder can use existing courier infrastructure and services with limited adaptation for a variety of necessary transactions including providing the reward and shipping a found item back to the item owner, and f) in many cases the found item can be shipped directly to the item owner rather than requiring one or more additional processing steps such as shipping to an intermediate lost-and-found facility and/or storage of the item in an inventory.

The various embodiments of the lost-and-found system and methods in accordance with the aspects of the present invention solve the problems associated with the techniques of the prior art. The lost-and-found system and methods in accordance with the various embodiments of the present invention have significant advantages to facilitate acceptance in the marketplace.

### BRIEF DESCRIPTION OF THE DRAWINGS

FIG. 1 is an elevational view of a preferred embodiment of the present invention.

FIG. 2 is an elevational view of the opposite side of the removable portion of the apparatus shown in FIG. 1.

FIG. 3 is an elevational view of the apparatus shown in FIG. 1 with the removable portion removed, and also illustrating a type of separable or non-separable protective material that may comprise the apparatus of FIG. 1.

FIG. 4 is an elevational view of a collapsible protective apparatus.

FIG. 5 is a perspective view of a protective apparatus which protects an item positioned in its interior from pressure along the height axis.

FIG. 6 is a perspective view of the apparatus in a preferred embodiment as a box.

FIG. 7 is a perspective view of the apparatus in a preferred embodiment as a collapsible box shown in a collapsed state.

FIG. 8 is a perspective view of the apparatus of FIG. 7 shown in an expanded state.

FIG. 9 is a perspective view of a shipping container designed to be shipped within another shipping container.

FIG. 10 is a top level flowchart of the system of the present invention.

FIG. 11 is a diagram of the determination function shown in FIG. 10.

FIG. 12 is a block diagram of a computer system for a lost-and-found system in accordance with an embodiment of the invention.

FIG. 13 is a block diagram of a computer having software for providing a lost-and-found system in accordance with an embodiment of the invention.

### DETAILED DESCRIPTION OF THE PREFERRED EMBODIMENTS

The present invention will be described in greater detail with respect to the preferred embodiments with reference to the drawing figures so as to exemplify the present invention. Various alternatives, refinements, and substitutions should become readily apparent to persons skilled in the art based on the principles of the invention illustrated herein.

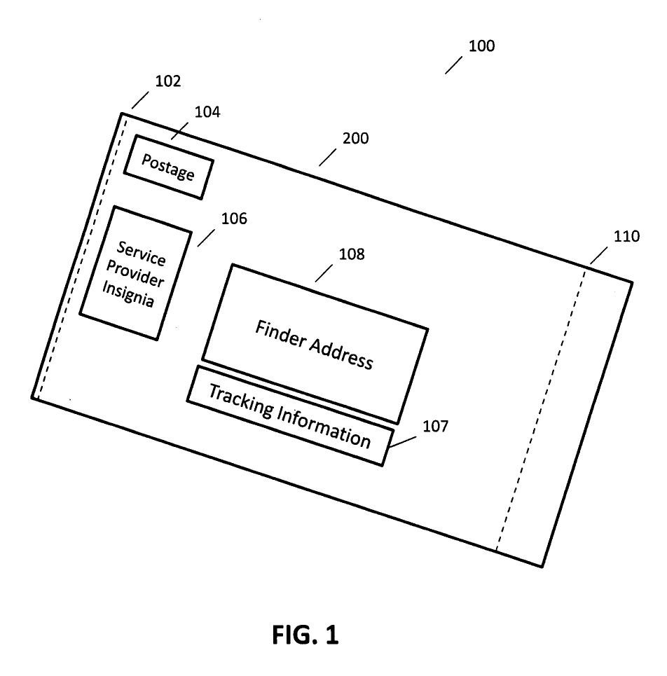

Referring first to FIG. 1, one embodiment of the present invention comprises an apparatus for returning a lost item to its owner. In a preferred embodiment of the present invention, the apparatus is a shipping container configured as a protective envelope 100. The envelope 100 preferably has means for paying a courier for shipping 104, means for indicating a lost-and-found service provider 106, and address indicating information of the item finder 108. Tracking information 107 is preferably provided on the envelope 100, which is used by UPS, Federal Express, the U.S. Postal Service, and/or the lost-and-found service provider to enable an item owner and/or other entity to retrieve shipping and/or other information about the status of the item. Systems and methods for using tracking information to track the shipment of a container are well-known to those skilled in the art and currently employed by the aforementioned couriers.

The envelope 100 also has a separable portion 200 which is attached at points of separation 102 and 110. In a preferred embodiment of the present invention, these points of separation 102 and 110 are created by perforating the paper of which the envelope 100 is constructed.

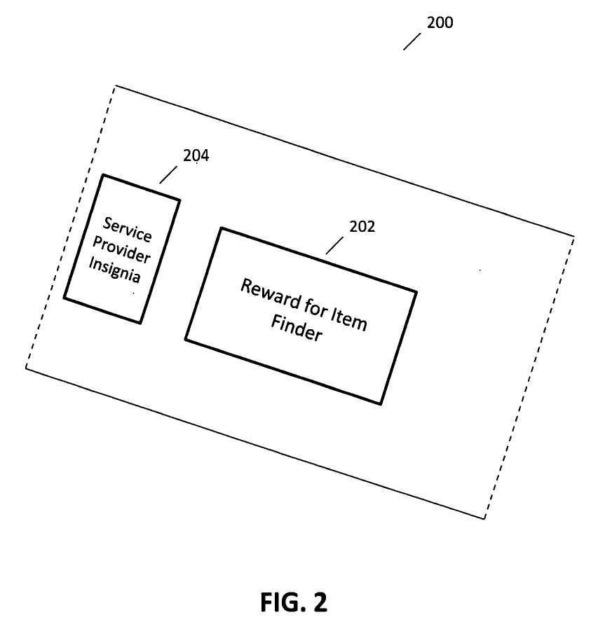

Referring now to FIG. 2, the opposite surface of the separable portion 200 is shown. In a preferred embodiment, the surface contains the insignia of the lost-and-found service provider 204 as well as means for providing a reward to the item finder 202. This means of providing a reward 202 may include, by way of example: a removable plastic gift card attached by adhesive to the surface of the paper, a printed coupon, a removable credit or debit card attached by adhesive to the surface of the paper, a code and/or message which enables subsequent retrieval of a reward, a gift certificate attached by adhesive and/or printed to the surface of the paper, and/or any means of conferring value that may be contemplated by those skilled in the art. By removing the separable portion 200, the item finder can access his or her reward.

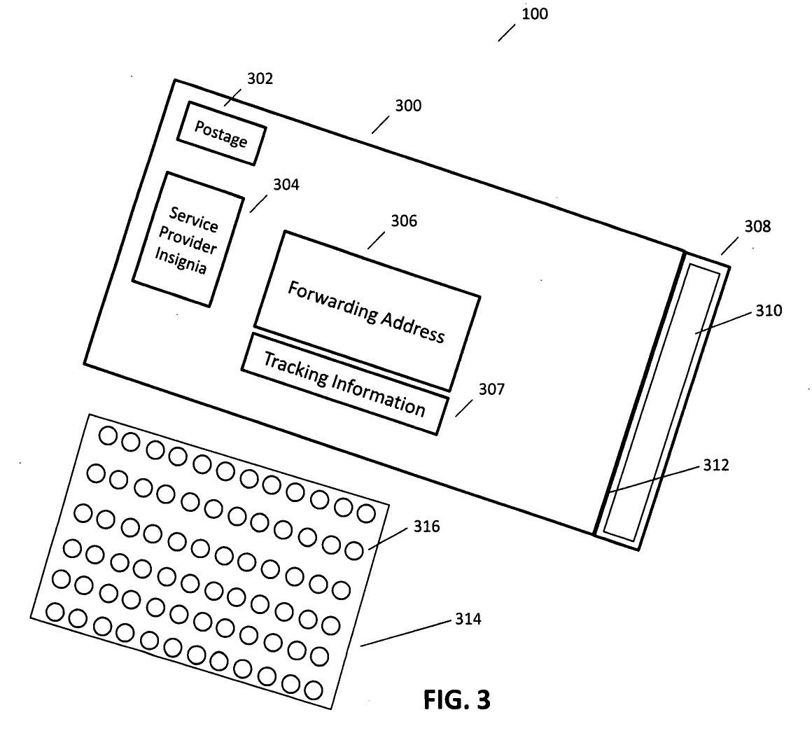

Referring now to FIG. 3, the envelope 100 of FIG. 1 is shown with the separable portion 200 removed. The removal of the separable portion 200 reveals the forwarding address 306 which directs a courier such as UPS, Federal Express, or the U.S. Postal Service where to ship the envelope 100. Tracking information 307 is preferably provided on the envelope 100, which is used by UPS, Federal Express, the U.S. Postal Service, and/or the lost-and-found service provider to enable an item owner and/or other entity to retrieve shipping and/or other information about the status of the item. In a preferred embodiment, means for paying a courier and/or lost-and-found service provider 302 and the lost-and-found service provider insignia 304 are printed and/or affixed to the surface 300 underlying the removable portion 200 of the envelope 100.

In accordance with a preferred embodiment, the envelope 100 is configured such that removing the separable portion 200 at the point of separation 110 makes accessible the protective interior 312 of the envelope 100 and also creates a foldable flap 308. On the interior side of the foldable flap 308 is adhesive means 310, of which many are known to those skilled in the art. After placing the found item within the protective interior 312, the foldable flap 308 may be folded over the opening to the protective interior 312 to seal the envelope 100.

In accordance with another preferred embodiment of the present invention, the envelope 100 contains protective material and/or mechanisms 314 of which a variety of means is known to those skilled in the art. The protective material and/or mechanisms 314 may be removable from the envelope 100 as illustrated by 314, or may be attached and/or configured within the protective interior 312. By way of example, the protective material 314 may contain many sealed air bubbles 316 which have protective properties. In the present example, the envelope 100 contains air bubbles 316 that are both attached to the protective interior 312 of the envelope 100 itself, and also includes a removable protective sheet 314 which an item finder can use to further protect an item before inserting it into the envelope. This example illustrates a preferred embodiment for providing an item finder with packing materials, such as bubble wrap or packing paper, to protect a found object, but many methods and means can be contemplated by those skilled in the art.

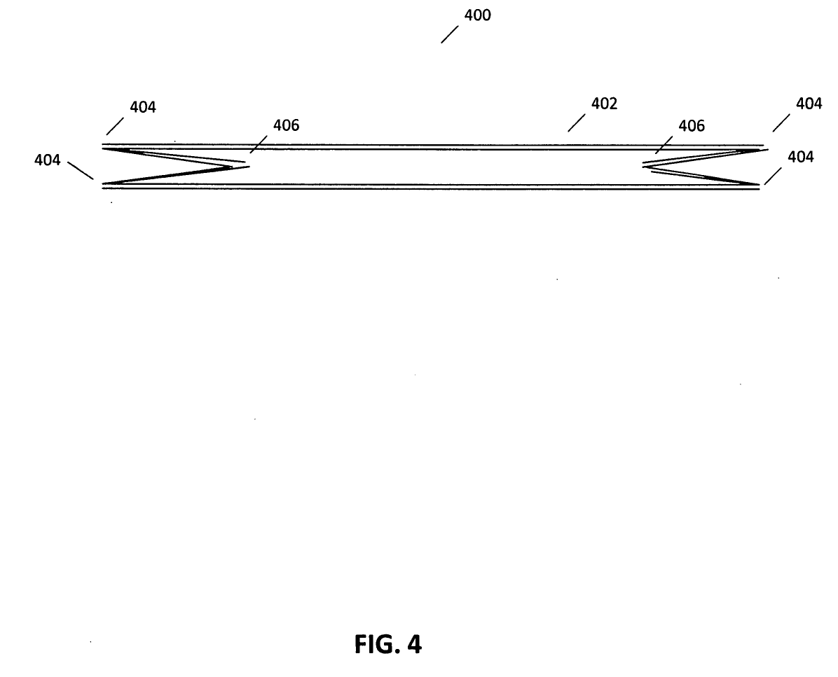

Referring now to FIG. 4, an apparatus 400 is shown which is designed to protect an object enclosed in an envelope 100 by offering structural integrity to a flexible shipping container. It is collapsible via folds 406 and 404 that enable it to be sent within a relatively flat envelope in order to minimize shipping fees. In accordance with a preferred embodiment of the present invention, the material of the apparatus 400 is corrugated cardboard, but those skilled in the art can contemplate many materials which offer comparable rigidity, protective quality, low cost, and ability to fold.

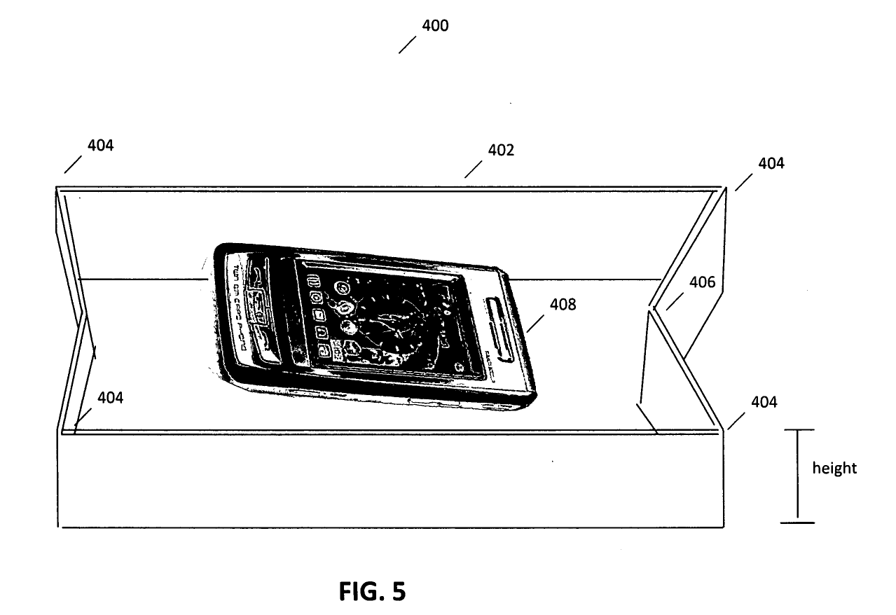

Referring now to FIG. 5, the apparatus 400 is shown in its expanded state. The apparatus 400 has been expanded at folds 406 and 404. The side walls 402 offer protection along the height axis against large objects positioned on top of the apparatus 400 and thus offer structural rigidity. By way of example, a mobile device 408 may be placed in the interior of the apparatus 400. In a preferred embodiment of the present invention, for expensive but fragile items such as cell phones or digital cameras, the apparatus 400 is shipped inside of the envelope 100 in its collapsed form to the item finder. Directions on the envelope 100 instruct the item finder to subsequently remove the apparatus 400 from the protective interior 312, expand the apparatus 400, and place the found item within the apparatus 400 before inserting the apparatus 400 and the item into the protective interior 312 of the envelope 100. Many means of protecting items within a shipping container 100 may be conceived by those skilled in the art, including those that both require protective measures by the item finder such as the use of the apparatus 400, and those that do not require additional protective measures by the item finder such as the use of heavily padded envelopes and/or boxes.

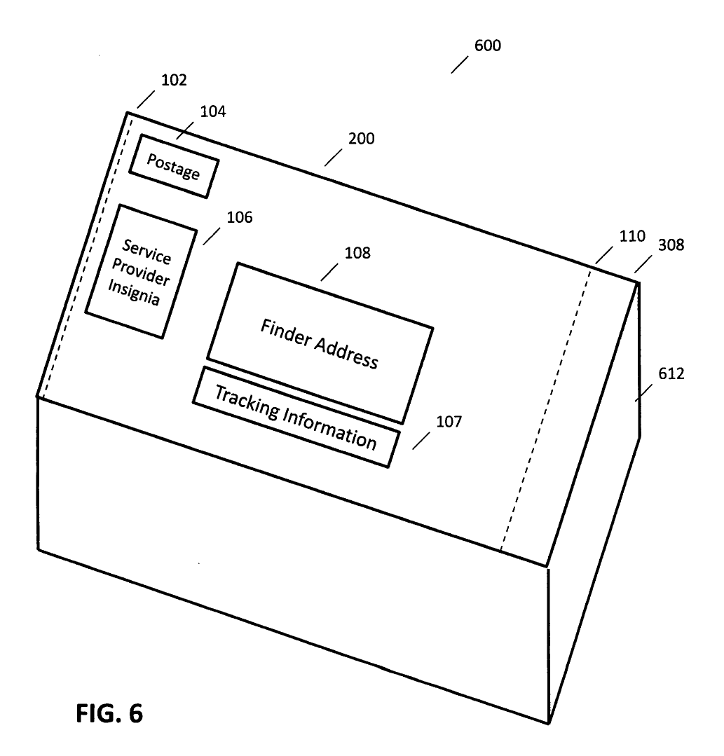

FIG. 6 illustrates a preferred embodiment of the present invention designed to accommodate larger and/or more fragile items, disclosing means to achieve the similar advantages as the aforementioned means described above. A box 600 is configured with a separable portion 200 which can be separated at points of separation 102 and 110. In a preferred embodiment of the present invention, the separable portion 200 is a paper material and the points of separation 102 and 110 are created by perforating paper which is attached to the box 600 at the lateral ends to the left and right of points of separation 102 and 110, respectively. One side of the box 612 is configured to open when the separable portion 200 is removed at the point of separation 110, thus providing access to the protective interior of the box 600 and creating a foldable flap 308. On the interior side of the foldable flap 308 is adhesive means, of which many are known to those skilled in the art. After placing the found item within the protective interior of the box 600, the foldable flap 308 and the opening side of the box 612 may be folded over the opening to the protective interior, and use of the adhesive means seals the box 600.

As described previously, a variety of means known to those skilled in the art can protect the item in the protective interior of the box 600. These include, but are not limited to, use of rigid materials in the construction of the box 600; use of a variety of attached and/or removable protective packing materials such as those illustrated by the bubble wrap 314 and structurally rigid collapsible cardboard 400, which may or may not be sent to the item finder in the box 600 to be used in packing the found item; and/or attachment of protective material such as bubble wrap 314 to the interior surfaces of the box 600.

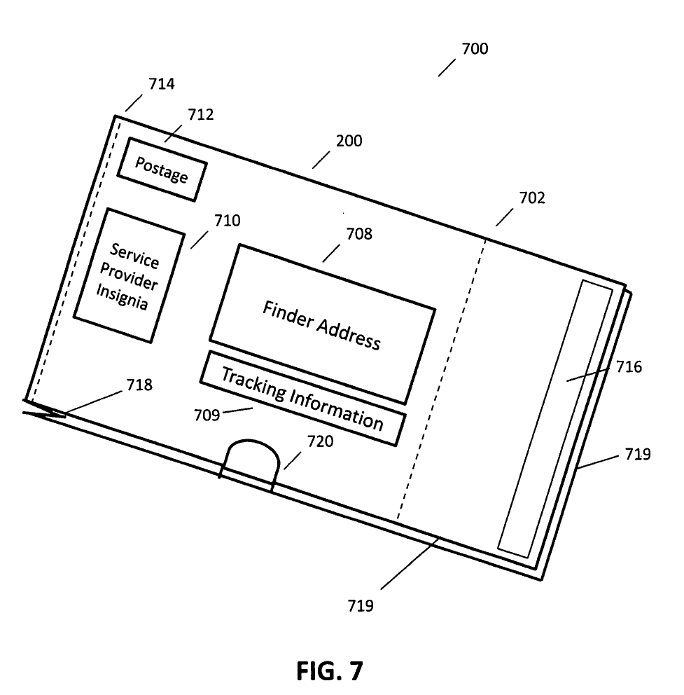

It may be desirable for the envelope 100 and/or box 600 to be collapsible in order to minimize shipping costs in providing the shipping container to the item finder while also providing sufficient size and/or protection for the item when it is subsequently shipped to the forwarding address. FIG. 7 illustrates a preferred embodiment of the present invention which serves these purposes.

The collapsible box 700 shown in FIG. 7 has a separable portion 200 with the characteristics described including the finder address 708, lost-and-found service provider insignia 710, tracking information 709, and means of paying a courier for shipment 712. The separable portion 200 is separable at the points of separation 714 and 702, preferably made separable by the use of perforations in paper that comprises the separable portion.

The ability to collapse and expand the box 700 is created by folds 718 at each corner at one end of the box 700 and sides configured to contract inward. There are many means of creating collapsible boxes 700 as are well-known to those skilled in the art, and companies such as Magellan Packaging manufacture a variety of boxes 700 of well-known construction that have this collapsing and expanding capability.

In accordance with a preferred embodiment of the present invention, one or more breakable seals 720 keep the box 700 collapsed until the seal is broken by the item finder in order to later insert the found item into the protective interior through the open end of the box 700 adjacent to the point of separation 702.

As shown in FIG. 7, the shipping container 700 also comprises foldable flaps 719. On the under side of the top foldable flap 719 is an adhesive means 716. In a preferred embodiment, the adhesive means 716 is a piece of plastic under which is an adhesive paste which becomes activated when the piece of plastic is removed, such as those manufactured by 3M Corporation. However, many adhesive means 716 are well-known to those skilled in the art.

The item finder may break the one or more seals 720 in order to expand the collapsible box 700. After inserting the found item via the opening to the box 700 on the right side as shown, the item finder may fold the bottom foldable flap 719 upwardly and then fold the top foldable flap 719 downwardly over the opening on the right side of the box 700 and use the adhesive means 716 to seal top foldable flap against the bottom foldable flap to close the box 700. In a preferred embodiment, the foldable flaps 719 are constructed of a rigid material in order to provide structural integrity to the box 700 after it is expanded and sealed.

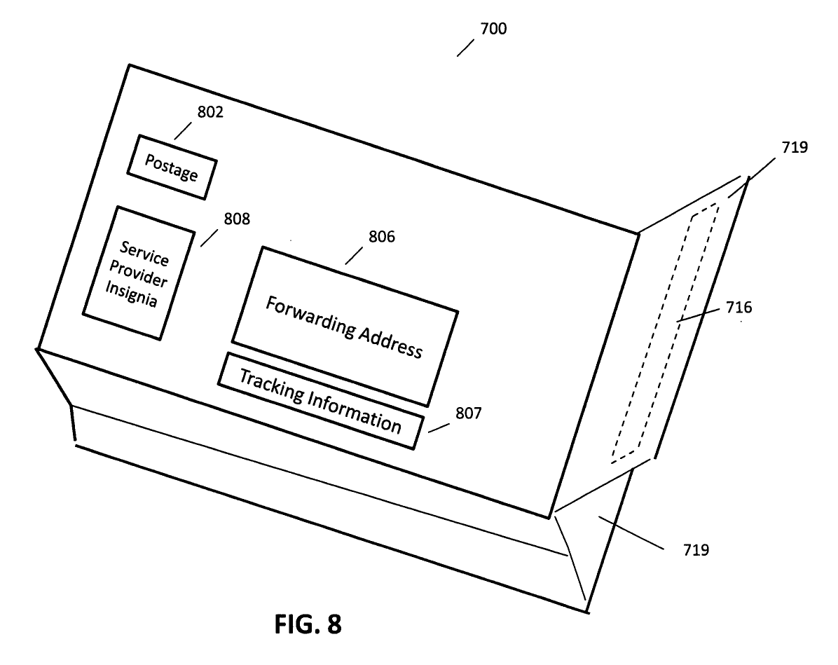

FIG. 8 shows the shipping container 700 of FIG. 7 with the separable portion 200 removed. Removing the separable portion 200 reveals the forwarding address 806, tracking information 807, the lost-and-found service provider insignia 808, and the payment means for a courier 802. FIG. 8 illustrates that the foldable flaps 719 have become the right side of the box 700 after it is sealed.

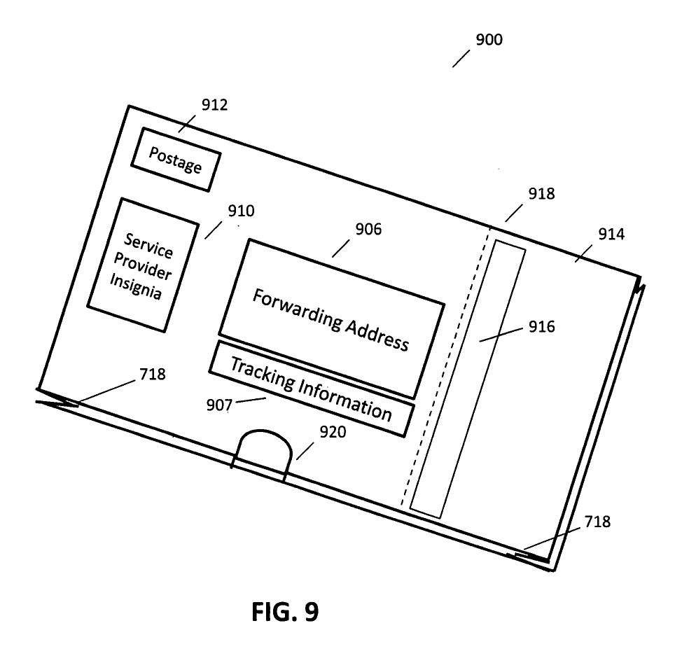

FIG. 9 shows a shipping container 900 which can be placed in the interior of an envelope or package sent to an item finder. A shipping container 900 containing another separable shipping container 900 shall be termed as one shipping container with a separable portion as described herein.

The shipping container 900 is collapsible and expandable in order to minimize shipping costs when sent to the item finder while accommodating the size and protective requirements of the found item when it is subsequently shipped to the item owner. In the present example, folds 718 at each corner of the box and in the side walls enable the box 900 to collapse and expand.

The shipping container 900 preferably includes payment means for a courier 912, lost-and-found service provider insignia 910, tracking information 907, and forwarding address 906 to which the found item will be sent after it is packed by the item finder. Additionally, it preferably includes one or more breakable seals 920 which keep the box 900 from expanding when it is being shipped to the item finder.

In accordance with a preferred embodiment of the present invention, the shipping container 900 has an opening on the right side as shown in FIG. 9, through which the item finder may insert an item into the box and remove any packing materials that were provided to the item finder by the lost-and-found service provider for the item's protection. In order to seal the box, there is a movable flap 914 which is adhered to the box 900 by an adhesive or other means at the point of separation 918. The item finder creates the movable flap by separating the movable flap from the shipping container 900 at the point of separation 918.

After inserting the found item via the opening to the shipping container 900 on the right side as shown, the item finder may fold the foldable flap 914 over the opening on the right side of the shipping container 900 and use the adhesive means 916 to seal the box 900. In a preferred embodiment, the foldable flap 914 is constructed of a rigid material in order to provide structural integrity to the shipping container 900 after it is expanded and sealed. It is necessary for the foldable flap 914 to be sufficiently large that it can be folded over the right side of the shipping container 900 as shown and sealed using the adhesive means 916.

Importantly, the item finder address is not included on the shipping container 900, as shown in FIG. 9. The reason is that in accordance with this embodiment of the present invention, the shipping container 900 would be placed in another shipping container which is addressed to the item finder. This preferred embodiment has the advantage of requiring less customization of the shipping containers involved in returning a lost item to its owner.

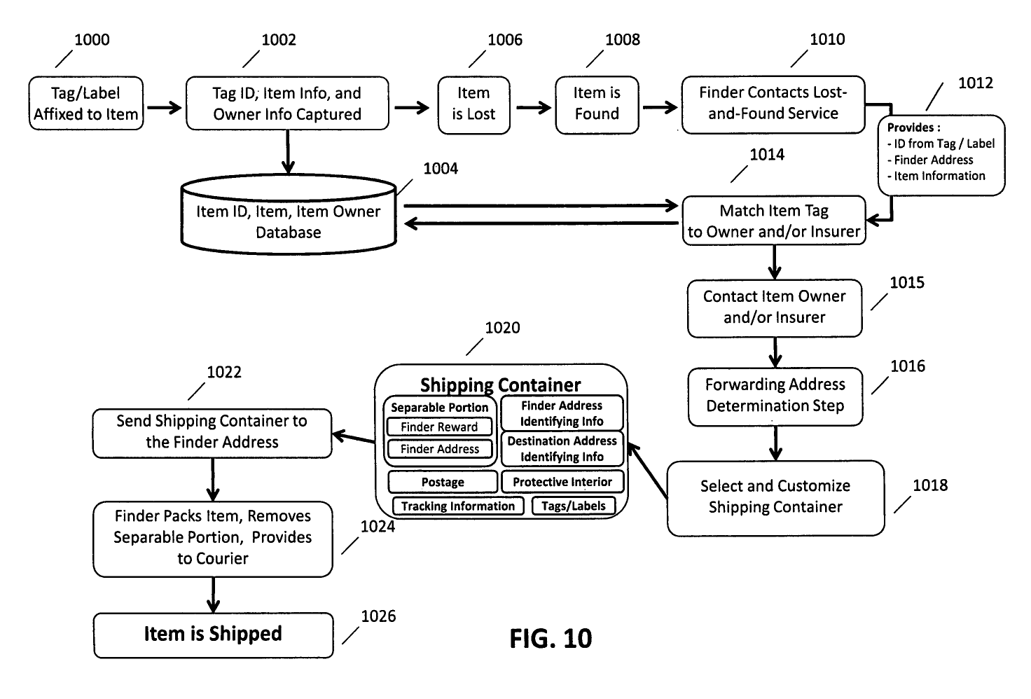

Referring now to FIG. 10, one embodiment of the present invention comprises a method for returning a lost item to its owner beginning in a step 1000 during which a tag and/or label is affixed to an item, the tag containing unique identifying information. In a step 1002, the unique identifying information on the tag and/or label is captured in a database 1004 with records for a plurality of tags and/or labels, wherein a tag and/or label with its unique identifying information corresponds to one or more records in the database 1004 containing a variety of information about the item and/or its owner.

In a step 1006, the tagged and/or labeled item is lost by an owner or possessor. In a step 1008 the item is subsequently found by another party.

In a step 1010, using the directions on the tag and/or label, the finder of the item (“item finder”) contacts a lost-and-found service provider and provides in a step 1012 information to the lost-and-found service such as the identifying information from the tag and/or label, the address of the finder in order to facilitate subsequent steps, and information about the found item such as its size, weight, type, etc. This information can be used in a step 1018 to ensure that the lost-and-found service properly selects and customizes an appropriate shipping container in step 1018 to facilitate the return of the item.

In a step 1014, the identifying information provided by the finder in step 1012 is used specifically to identify item information and item owner information from the database 1004, preferably including item owner address and item owner contact information. This information retrieved in step 1014 may also include information about insurance on the item against loss or theft. Preferably, insurance information retrieved about the item includes one or more of the following: whether or not the item is insured, the terms of the theft or loss insurance, whether the insurance will pay any incentive to the finder for the return of the item, and/or whether the insurance will pay any shipping and/or other fees for the return of the item.

In a step 1015, the lost-and-found service provider contacts the item owner and/or insurer if the item is insured against loss or theft. In this step, the lost-and-found service preferably seeks to achieve one or more of the following: a) notify the owner and/or insurer, if applicable, that the item has been found and thus does not necessarily need to be replaced, b) obtain payment means in order to pay the lost-and-found service provider for processing and fees related to returning the item such as, by way of example: shipping fees, incentive fees for the finder, processing fees, deductible payments, etc., c) verify the proper return address for the item, and/or d) determine whether or not the item owner and/or insurer wants the item returned, thus potentially incurring costs associated with return, or whether the owner and/or insurer prefer that the item be discarded. In another preferred embodiment of the present invention, upon contact of the item owner in step 1015 after an item is found, the unique identifying information on the found item is provided to the item owner by which the item owner can obtain information about the status of the item from the lost-and-found service provider. In another preferred embodiment of the present invention, unique identifying information is generated by software and a computer system and is provided to the item owner, thus enabling the owner to obtain information about the status of the item from the lost-and-found service provider.

In another preferred embodiment of the present invention, upon contact of the item owner in step 1015 after an item is found, the item owner is provided unique tracking information contained on the found item and/or a shipping container used to ship the found item, wherein said tracking information can be used with a courier such as Federal Express, UPS, or U.S. Postal Service to identify the shipping status and/or location of an item in transit. In another preferred embodiment of the present invention, the item owner is provided with the name of the courier for which the tracking identifying information may be used.

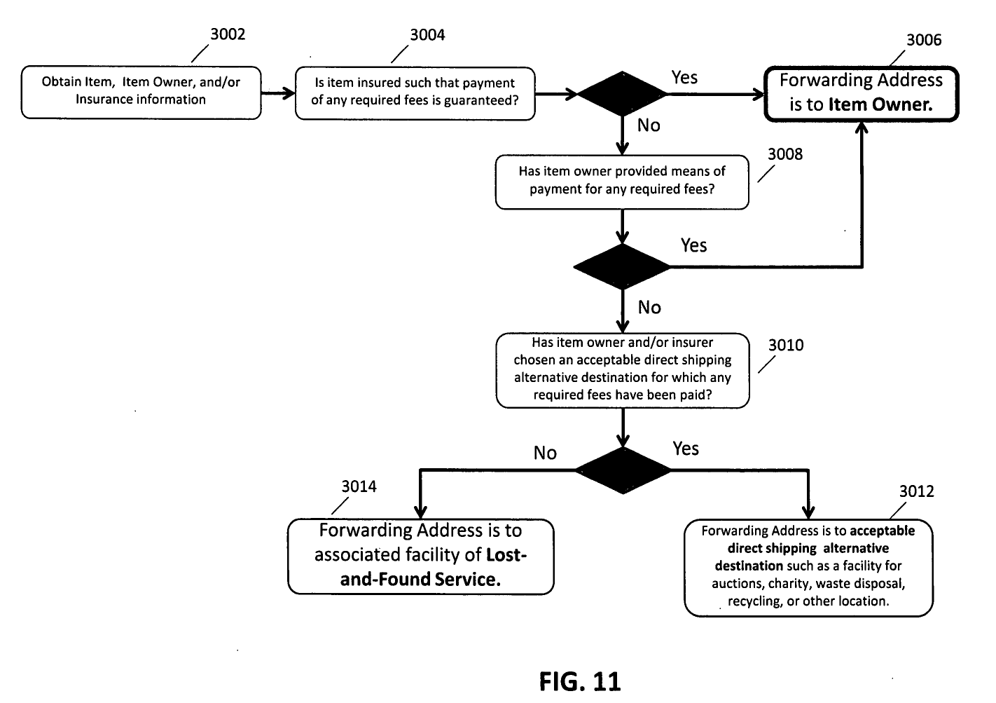

In a step 1016, the lost-and-found service provider must determine the proper forwarding address to which the item will be sent, and thus the address which must be printed and/or otherwise affixed to the shipping container 1020 as determined in step 1018. FIG. 11 is a detailed flowchart describing the systems logic for the determination steps 1016 and 1018. There are a variety of destinations to which the shipping container 1020 can be forwarded including but not limited to: a) the item owner, b) a facility of a lost-and-found service provider for subsequent processing and/or storage, c) an auction service, d) a charitable organization, e) a disposal facility, and/or f) a recycling facility. The selection of the forwarding address is preferably determined in step 1016 as described in more detail in FIG. 11.

Referring now to FIG. 11, a computer-enabled system determines the forwarding address which is pre-printed and/or affixed to the shipping container 1020. The forwarding address is the address to which the shipping container 1020 will be sent after the item finder has inserted the item into the protective interior of a shipping container 1020.

The goals of the determination step 1018 in FIG. 10 are to: a) minimize logistics costs, b) assure that payment means exists to compensate for the return of the item to the item owner including such fees as an incentive to the item finder for returning the item, processing fees, shipping fees, and/or other fees, c) in the case that an item owner and/or insurer does not wish the item be returned to its owner, minimize costs in enabling the proper handling of the item, and d) in the case that an item owner and/or insurer may want the item returned but has not provided any required payment for its return, enable intermediate processing by a lost-and-found service provider.

In a step 3002, information including but not limited to information about the found item, its owner, and any insurance that reimburses the owner against loss of the item is identified as described previously in FIG. 10 and its accompanying description. In a step 3004, a determination is made as to whether or not the item is insured such that any fees associated with returning the item to its owner, such as incentive fees for the item finder, shipping fees, deductibles, and/or processing fees, are guaranteed to be paid to the lost-and-found service provider and/or other entities in exchange for returning the item to the item owner. If the determination is yes, in a step 3006 the forwarding address is determined to be the address of the item owner.

If the answer is no, in a step 3008 a determination is made such that any fees associated with returning the item to its owner, such as incentive fees for the item finder, shipping fees, deductibles, and/or processing fees, are guaranteed to be paid to the lost-and-found service provider and/or other entities in exchange for returning the item to the item owner. If the answer is yes, in step 3006 the forwarding address is determined to be the address of the item owner.

If the answer to the determination made in step 3008 is no, in a step 3010 a determination is made as to whether the item owner and/or insurer has indicated an “acceptable direct shipping alternative” to having the item returned to the item owner. An “acceptable direct shipping alternative” is an alternative destination for which fees required by the lost-and-found service provider, if any, have been paid and/or to which the lost-and-found service provider has agreed to ship the item directly using the shipping container 1020. By way of example, a lost-and-found service provider may agree to waive fees on any shipping and/or processing of a found item in exchange for rights to auction the item and profit from some percentage of the auction proceeds from sale of the item at auction. In a step 3010, should an item owner and/or insurer agree to auction a found item rather than return it to its owner, and should an auction facility appropriate for auctioning the item be an acceptable direct shipping alternative destination per the lost-and-found service, in a step 3012 the lost-and-found service provider may ship the lost item directly to an auction service.

In step 3010, if the item owner and/or insurer has not chosen an acceptable direct shipping alternative destination, then in a step 3014 the forwarding address is to an associated facility of the lost-and-found service provider. The associated facility of a lost-and-found service provider is any facility that assists in the shipping and/or other processing of a lost and/or found item. Shipping the item to an associated facility of a lost-and-found service provider enables said provider to perform additional processing steps, by way of example, including but not limited to: a) trying to obtain payment of any required fees from the item owner and/or insurer, b) disposing of the item, c) recycling the item, d) auctioning the item, e) forwarding the item to its owner, f) donating the item to a public service and/or community organization such as a police station, and/or g) otherwise processing the item.

The method illustrated in FIG. 11 has the advantages of enabling: a) shipping the item directly from the item finder to the item owner if requisite fees have been paid by the insurer and/or item owner, b) shipping the item directly from the item finder to an acceptable alternative destination, if appropriate, without intermediate processing by the lost-and-found service provider, and c) enabling the finder to conveniently and inexpensively forward the item if the item's final destination has not been determined at the time of preparation of the shipping container.

Referring again to FIG. 10, in step 1018, a shipping container 1020 is selected and customized by an entity which may include but is not limited to a lost-and-found service provider, a courier service (which may itself be a lost-and-found service provider), a fulfillment service provider, or other entity. A shipping container 1020 may be selected from a variety of shipping containers 1020 with various sizes, weights, protective characteristics, reward means for finders, payment means for couriers, finder address, forwarding address, tracking information, and other characteristics. The selection and/or customization of the shipping container 1020 performed in step 1018 is based on a variety of factors including but not limited to, individually or in combination: a) the fragility of the item per information gathered in one or more of steps 1012, 1014, and/or 1015, thus determining the protective characteristics of the shipping container 1020, b) the size and/or weight of the item per information gathered in one or more of steps 1012, 1014, and/or 1015, thus determining characteristics of the shipping container 1020 such as postage, size, packaging strength, and protective characteristics, c) the reward offered as an incentive to the finder for returning the item as gathered in one or more of steps 1012, 1014, and/or 1015, d) the forwarding address determined in the address determination step 1016 to which a separable portion of the shipping container can be sent after the item is enclosed in the shipping container 1020 by the item finder, and e) the finder address gathered in step 1012. These factors determine the selection and/or customization of the shipping container 1020 in step 1018.

In a preferred embodiment of the present invention, the shipping container is sent to the item finder and/or item owner containing one or more labels or tags which can be affixed to an item such that if the item is lost and subsequently found, the affixed label or tag may be used to facilitate the return of the item to the item owner. This embodiment of the present invention has the benefit of enabling the lost-and-found service provider to sell additional lost-and-found service provider labels or tags to item finders and/or item owners for whom the value of the lost-and-found service may be readily apparent. In another preferred embodiment of the present invention, the item finder or item owner using a said label or tag must pay the lost-and-found service provider to activate the label or tag before the lost-and-found service provider will facilitate the return of an item marked with said label or tag, if said item is lost and returned. In another preferred embodiment of the present invention, a label or tag is provided on both the removable portion 200 of the shipping container 100 and in the protective interior 312 such that when the shipping container 100 is sent to the item finder, the item finder may receive a label or tag, and when the shipping container 100 is forwarded to the item owner, the item owner may also receive a label or tag.

In a step 1022 shown in FIG. 10, a lost-and-found service, courier service, fulfillment service, and/or other entity sends a shipping container 1020 to the item finder at the finder address collected in step 1012, the shipping container having the characteristics determined in step 1018. In a step 1024, the item finder inserts the item into a protective interior of the shipping container 1020 and preferably removes a separable portion of the shipping container containing the finder's address, incentives to the item finder for returning the item, advertising information, and/or other information, and seals the protective interior of the shipping container 1020 with the found item enclosed. Continuing in step 1024, the item finder returns the shipping container 1020 to a courier such as the U.S. Postal Service, Federal Express, or UPS. In a step 1026, the forwarding address determined in step 1016 becomes the operative address to inform the return of the object by a courier to the proper destination.

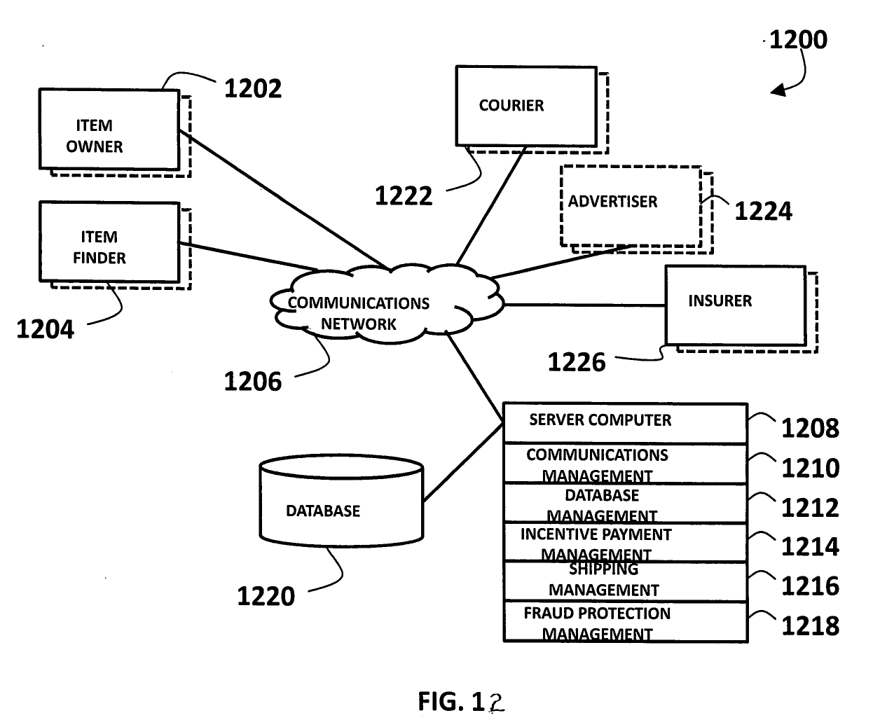

FIG. 12 is a block diagram of a computer system for providing a lost-and-found system in accordance with an embodiment of the present invention. In one embodiment, computer system 1200 includes an item owner 1202; an item finder 1204; a communications network 1206; a server computer 1208 having a communications management component 1210, a database management component 1212, an incentive payment management component 1214, a shipping management component 1216, and a fraud protection management component 1218; a database 1220 which in part is comprised of the database 1004; a courier 1222; an advertiser 1224; and an insurer 1226. The item owner 1202, the item finder 1204, the courier 1222, the advertiser 1224, and the insurer 1226 are communicatably linked with the server computer 1208 over the communications network 1206. The server computer 1208 is communicatably linked with the database 1220. Any of the elements of FIG. 12 can be eliminated or distributed.

In one embodiment, the server computer 1208 implements one or more embodiments of the methods described in reference to FIG. 10 and FIG. 11. Accordingly, in one particular embodiment, the item owner 1202 couples a label or tag having identifying information to an item. The identifying information of the label or tag is associated with the item owner 1202 in the database 1220. When the item is found by the item finder 1204, the item finder 1204 provides the server computer 1208 the identifying information over the communications network 1206. The communications management component 1210 receives the identifying information, and the database management component 1212 determines the item owner 1202 and the incentive payment information in the database 1220. The communications management component 1210 notifies the item owner of the found status of the item, and the incentive payment management component 1214 ensures that the incentive payment is satisfied by the item owner 1202 and/or the insurer 1226. Upon satisfaction of the incentive payment, the shipping management component 1216 of the server computer 1208 prepares the incentive payment, packaging, and labels for sending to the item finder 1204. When the item finder 1204 receives the incentive payment and packaging, the item finder 1204 retains the incentive payment, inserts the item into the packaging, and forwards the item to the item owner 1202 using the courier 1222. Upon receipt of the item by the item owner 1202, the fraud protection management component 1218 activates the incentive payment. The advertiser 1224 optionally provides coupons or discounts to the item finder 1204 as a substitute for the incentive payment when such incentive payment is not satisfied.

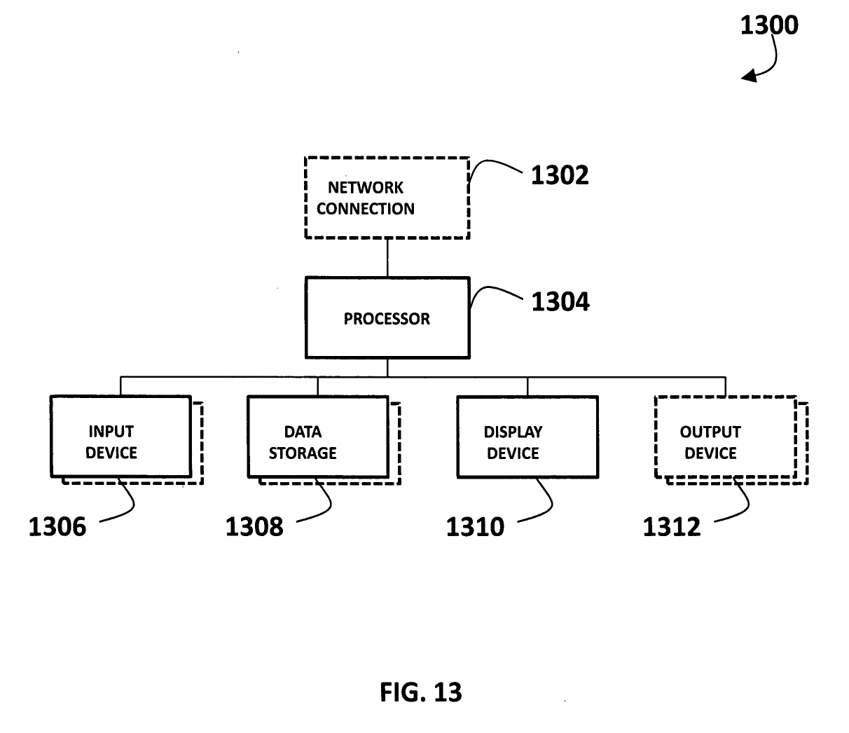

FIG. 13 is a block diagram of a computer having software for providing a lost-and-found system in accordance with an embodiment of the present invention. In one embodiment, the computer having software 1300 includes a network connection 1302, a processor 1304, an input device 1306, data storage 1308, a display device 1310, and an output device 1312.

In one embodiment, the computer having software 1300 is configurable to implement one or more embodiments of the methods described in reference to FIG. 10 and FIG. 11. Accordingly, in one particular embodiment, the processor 1304 receives notice of a found item over the network connection 1302 that includes identifying information from a label or tag on a found item. The processor 1304 accesses the data storage 1308 and determines owner information for the found item using the identifying information from the label or tag. The owner information includes owner contact information, incentive payment information, and insurance information and may be displayed on the display device 1310. The processor 1304 informs the item owner over the network connection 1302 that the item has been found, verifies owner contact information, confirms the identity of the item, and confirms that the owner wants the item returned. The processor 1304 determines whether the incentive payment has been prepaid and if not, whether the owner or any insurance provider is responsible for any unpaid incentive payment. If the incentive payment is unpaid, the processor 1304 contacts the item owner or any insurance provider to collect the incentive payment. Upon the incentive payment being satisfied, the processor 1304 prepares the incentive payment, labels, and packaging using the output device 1312. When the item is successfully received by the item owner, the processor 1304 then activates the incentive payment over the network connection 1302.

The aforementioned system has a great many advantages over known systems. These advantages include but are not limited to:
a) Enables a found item to be sent directly from the item finder to the item owner without intermediate processing at a central facility;
b) Does not require a costly and inconvenient scheduled courier pickup to retrieve the item from the item finder;
c) Does not require that the item finder make a costly and inconvenient trip to a courier service such as a UPS Store®;
d) Does not compromise the anonymity of the item finder to the item owner;
e) Enables the use of only one courier correspondence with the item finder to both facilitate retrieval of the item and provide a reward to the item finder; and
f) Can be executed using the standard services of couriers such as Federal Express, the U.S. Postal Service, and UPS.

While the foregoing description has been with reference to particular embodiments of the present invention, it will be appreciated by those skilled in the art that changes in these embodiments may be made without departing from the principles and spirit of the invention. Accordingly, the scope of the present invention can only be ascertained with reference to the appended claims.

What is claimed is:

1. A shipping container used for returning a lost item to its owner, comprising:
a protective interior to contain and protect a found item;
at least one portion of the shipping container which communicates an address of an item finder and contains a reward to the finder for finding the item;
at least one portion of the shipping container which communicates a forwarding address; and
an indicator of a guarantee of payment to a courier in exchange for shipping the container to the forwarding address.

2. The shipping container of claim 1, further comprising at least one portion of the shipping container which communicates an insignia of a lost-and-found services provider.

3. A method for returning lost items to their owners, comprising the steps of:
confirming that payment has been made for the return of an item to its owner;
affixing or printing the address of the item owner on a shipping container;
affixing or printing the address of the item finder on a shipping container;
making the address of the item finder the operative destination for the first shipping of the shipping container; and
making the address of the item owner the operative destination for the second shipping of the shipping container.

4. The method of claim 3 wherein the step of confirming that required payment has been made for the return of an item to its owner comprises the step of determining that the item is insured for loss.
